(19) United States
(12) Patent Application Publication
(10) Pub. No.: US 2025/0134119 A1
(43) Pub. Date: May 1, 2025

(54) COOLING DEVICE FOR FOOD PRODUCTS

(71) Applicant: Heat and Control, Inc., Hayward, CA (US)

(72) Inventors: Anthony Caridis, Danville, CA (US); Steven Michael Konold, Camas, WA (US); James Anthony Padilla, Pacifica, CA (US); Mohammad Imran Osman, Fairfield, CA (US)

(73) Assignee: Heat and Control, Inc., Hayward, CA (US)

(21) Appl. No.: 18/934,925

(22) Filed: Nov. 1, 2024

Related U.S. Application Data
(60) Provisional application No. 63/595,191, filed on Nov. 1, 2023.

(51) Int. Cl. A23L 3/36; F25D 17/08; F25D 23/06; F25D 25/04

(52) U.S. Cl. CPC A23B 2/803; F25D 17/08; F25D 25/04; F25D 23/061; F25D 2317/063; F25D 2317/0665; F25D 2317/067; F25D 2323/00281

(57) ABSTRACT

A cooling device for products disposed in an arrangement including an elongate plenum having a length that approximates the transverse dimension of the arrangement and a passageway extending from its first end to its second end. A structure coupled to the elongate plenum is adapted for positioning the elongate plenum across arrangement. A blower is coupled to the first end of the elongate plenum for providing a pressurized fluid to the passageway. The elongate plenum has a substantially continuous nozzle extending along its length for directing pressurized fluid from the passageway for travel over a side wall of the plenum towards the arrangement. The side wall has a configuration so that the pressurized fluid traveling over the side wall entrains fluid external of the elongate plenum for amplified cooling of products in the arrangement.

### CROSS REFERENCE TO RELATED APPLICATION

This application claims priority U.S. provisional patent application Ser. No. 63/595,191 filed Nov. 1, 2023, the entire content of each of which is incorporated herein by this reference.

### FIELD OF THE INVENTION

This invention relates generally to cooling devices, and more particularly to cooling devices for use with food processing machinery.

### BACKGROUND OF THE INVENTION

Cooling devices have been provided, for example for cooling food products disposed on a surface in a food processing system. Such cooling devices often use large electric motors, requiring large amounts of energy, and often provide nonuniform cooling across the surface.

Improvements are needed in cooling devices used in food processing systems to reduce energy consumption and provide more uniform cooling.

### BRIEF DESCRIPTION OF THE DRAWINGS

FIG. 1 is a top plan view of an embodiment of two overhead cooling devices of the invention mounted over a food carrying surface.

FIG. 2 is a front elevational view of the overhead cooling devices and food carrying surface of FIG. 1 taken along the line 2-2 of FIG. 1.

FIG. 3 is an isometric view of an overhead cooling device of FIG. 1.

FIG. 4 is a cross-sectional view of an air entrainment duct of an overhead cooling device of FIG. 1 taken along the line 4-4 of FIG. 1.

FIG. 5 is a cross-sectional view of an embodiment of a nozzle of the air entrainment duct of FIG. 4 taken along the line 5-5 of FIG. 4.

FIG. 6 is a cross-sectional view, similar to FIG. 5, of another embodiment of the nozzle of the air entrainment duct of FIG. 4.

FIG. 7 is an isometric view of an embodiment of a manifold for connecting a blower to an air entrainment duct of an overhead cooling device of FIG. 1.

FIG. 8 is a plan view of the manifold of FIG. 7 taken along the line 8-8 of FIG. 7.

FIG. 9 is a cross-sectional view of the air entrainment ducts of an air cooling device of FIG. 1, taken along the line 9-9 of FIG. 1, in operation.

### DETAILED DESCRIPTION OF THE INVENTION

A device for cooling one or more products is provided. The device can optionally be used for simultaneously cooling a plurality of products, which can optionally be in a stationary batch or continuously moving under or relative to the device. The products can be of any suitable type, including food products of any type. The products can optionally be disposed, carried or otherwise positioned or placed on a surface, in a horizontal, vertical or any other arrangement or configuration or in any combination of the foregoing. For simplicity, the surface, arrangement or configuration shall be referred to herein as a surface, and can optionally be referred to as a food carrying surface. The surface can optionally be a moving surface, for example a conveyor. The surface, or arrangement or configuration of products for processing, can optionally have a transverse dimension, for example a width, and the device can optionally extend across or substantially across the transverse dimension.

The device can have a blower, or blowers, positioned to the side of the surface, or arrangement or configuration of products, for example not thereover. The device can optionally be configured to provide a substantially uniform curtain or substantially uniform area of fluid to the surface, to the products disposed or carried on the surface or to the arrangement or configuration of products. A plurality of devices can optionally be provided and arranged relative to the surface or to the arrangement or configuration of products in any suitable manner, for example side by side or parallel to each other, to blow air on an area of the surface, arrangement or configuration. The device can optionally be called a cooling device. The cooling device can optionally be positioned relative to the products, for example on the surface, to blow air or any other fluid towards or on the products. The cooling device can optionally be used in a food processing system, for example to cool food after the food has been heat treated, for example fried, baked or otherwise heated. The cooling device can optionally be positioned over the products, for example over food products moving on a conveyor or other moving surface or over moving food products in an arrangement or configuration.

The device can optionally include a structure of any suitable type coupled to one or more plenums for fixing the position of the plenum(s) relative to the products or surface during operation of the device. Each plenum of the device can optionally be referred to as a duct, fluid entrainment duct or air entrainment duct. The structure can optionally include a first portion coupled or joined to the first end of the plenum and second portion coupled or joined to the second end of the plenum. The structure can optionally include a leg or other support joined to each end of the plenum. The structure can optionally be configured to removably secure the plenum to the support structure of the surface, for example the opposite sides of a conveyor, or to the support structure for moving arrangements or configurations of products.

The device can optionally include at least one plenum or any suitable type or shape, for example an elongate or linear plenum. The plenum can optionally have a length approximating the transverse dimension of the surface or arrangement or configuration of products, greater than the transverse dimension, sufficient to extend across the surface or arrangement or configuration or any combination of the foregoing. The length can optionally extend from a first end to a second end of the plenum. The plenum can optionally be tubular. The plenum can optionally have a passageway extending from its first end to its second end, for example the length of the plenum. A blower can optionally be coupled to the plenum for providing a pressurized fluid, for example air, to the passageway. The blower can optionally be coupled to the first end of the plenum, for example to extend away from the first end. The second end of the plenum can optionally be closed, for example permanently or selectively.

The plenum can optionally have at least one side wall, and can optionally include or be opposite first and second side walls. At least one side wall of the plenum, including for example both of the first side wall and second side wall, can optionally be provided with a nozzle, for example a linear nozzle. The nozzle can optionally extend along the length of the respective side wall, for example at least a portion of the length or the entire length. The nozzle can optionally extend parallel to the axis of the plenum. The nozzle can optionally be continuous or substantially continuous along its length. The nozzle can optionally direct pressurized fluid, for example provided by the blower, towards the surface or product, for example along the length of the plenum. The pressurized fluid from the nozzle can optionally be directed for travel over the respective side wall towards the product. At least a portion of the side wall can be configured to increase the velocity of the pressurized fluid, to entrain fluid adjacent to the side wall or both for amplifying or increasing the volume of pressurized fluid being directed towards the product. At least a portion of the side wall, for example a portion adjacent or close to the nozzle, can have a surface optionally configured or referred to as a Coanda surface. At least a portion of the side wall, for example between the Coanda surface and product, can have a surface optionally configured or referred to as a diffuser surface.

The device can optionally include a plurality of plenums disposed side by side to each other, for example parallel to each other, and each having a first side wall and an opposite second side wall. Each side wall can be provided with a nozzle, for example a linear nozzle of any of the type disclosed herein. Each side wall can have any of the configurations disclosed herein. The plurality of plenum can be spaced apart, but sufficiently close to each adjacent plenum, to provide a substantially uniform area of pressurized fluid to the product or surface carrying the product.

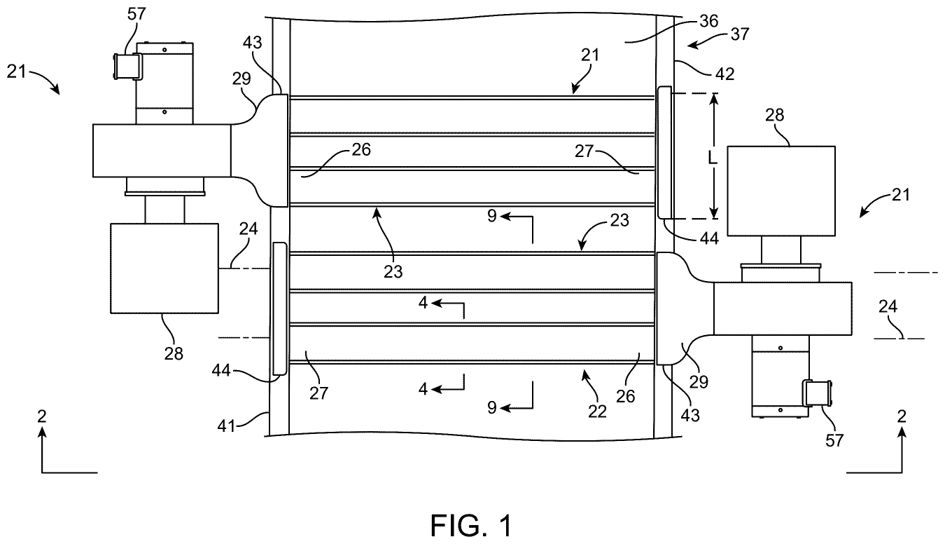

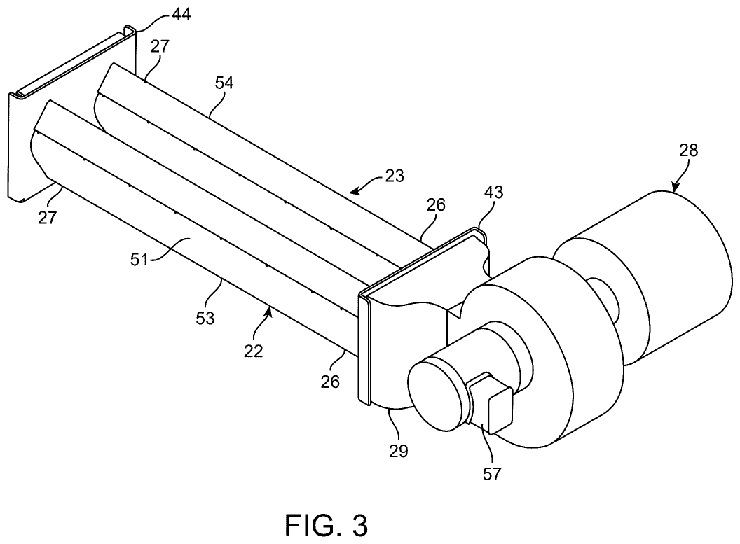

An embodiment of the device of the invention, which can optionally be referred to as a cooling device, is illustrated in FIGS. 1-9. It is appreciated that numerous other embodiments can be provided, including any portions of the illustrated embodiment, any portion of the device disclosed herein, any combination of the foregoing or more, and the invention is broad enough to cover all such other embodiments.

Device 21 can be used for cooling products, for example food products of any suitable type. Device 21 can optionally be used for simultaneously cooling a plurality of food products, which can optionally be moving relative to the device 21, for example in a continuous cooling process, or stationary relative to the device. Device 21 includes at least one plenum and can optionally include a plurality of plenum, for example first or left plenum 22 and second or right plenum 23. It is appreciated that device 21 can be provided with three or more plenums. Each plenum 22, 23 can optionally be referred to as an elongate plenum and extend along an axis 24, which can optionally be referred to as a longitudinal axis of the plenum. Each plenum 22, 23 can optionally have a first end 26 and an opposite second end 27. One or more blowers can provide a suitable pressurized fluid, for example air, to the plenums. A single blower 28 of any suitable type can optionally be coupled to each of the plenums 22, 23, for example to the open first end 26 of each plenum. An optional manifold 29 of any suitable type can be provided for distributing, for example uniformly distributing, the pressurized fluid from the blower 28 to each of the plenums 22, 23. The manifold can optionally be referred to as a distribution manifold or fluid distribution manifold. The distribution manifold 29 can be coupled between the blower and the plenums, for example joined to the output of the blower 28 and to the first end 26 of each of the plenums. The second end 27 of each plenum 22, 23 can optionally be a closed end, for example by means of a fluid tight seal. The closed second end can optionally be a selectively closable end, for example capable of being opened to access the interior of the plenum and capable of being closed to provide a fluid tight seal at the second end.

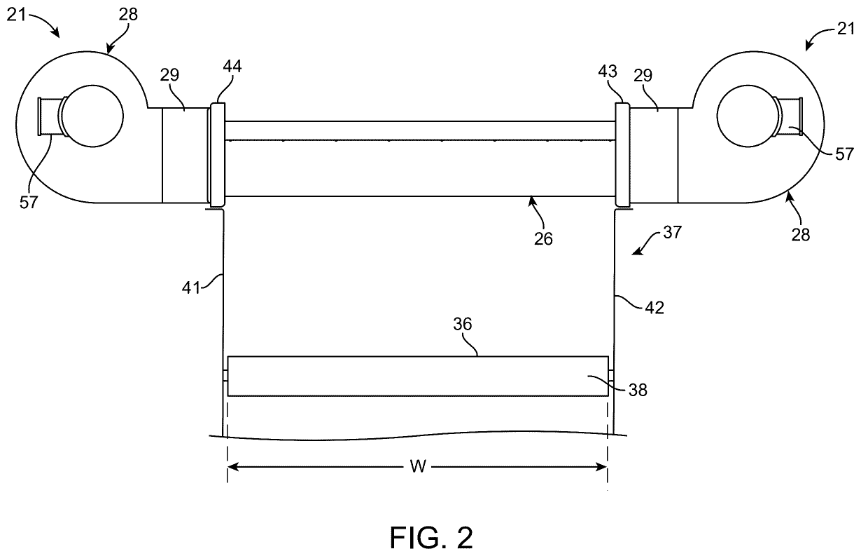

Device 21 can be used for cooling one or more products, for example food products of any suitable type. The products can optionally be disposed, carried or otherwise positioned or placed on a surface or in a horizontal, vertical or any other arrangement or configuration. The surface can optionally be referred to as a food carrying surface. The surface can optionally be a moving surface, for example a moving surface 36 of a conveyor system 37. The surface 36 can be a surface of a moving conveyor belt 38 of the conveyor system. The conveyor surface can optionally have a transverse dimension, for example a width W (see FIG. 2). The conveyor system 37 can optionally include opposite side walls, for example first side wall 41 and opposite second side wall 42, extending upwardly along the sides of the conveyor belt 38. The rollers (not shown) of the conveyor system are pivotably coupled to the side walls 41, 42 so that the conveyor belt 38 and surface 36 move horizontally along the side walls. Device 21 can optionally extend across or substantially across the transverse dimension, or width, of the surface 36. The device can optionally include a structure of any suitable type coupled to the one or more plenums of the device for positioning the one or more plenums, for example plenums 22, 23, across the surface 36 or relative to any other arrangement or configuration of products. The structure can optionally couple each end of the device 21 to side walls 41, 42 of the conveyor system 37, and can optionally include a first framework 43 at the first end 26 of the one or more plenums of the device 21 for resting on or otherwise coupling to first side wall 41 and a second framework 44 at the second end of the one or more plenums of the device for resting on or otherwise in coupling to second side wall 42. It is appreciated that the structure can have a variety of configurations, including for example legs, brackets, self-supporting C-frames or any combination of the above. Cooling device 21 can optionally be positioned over tables for bins for batch-style cooling.

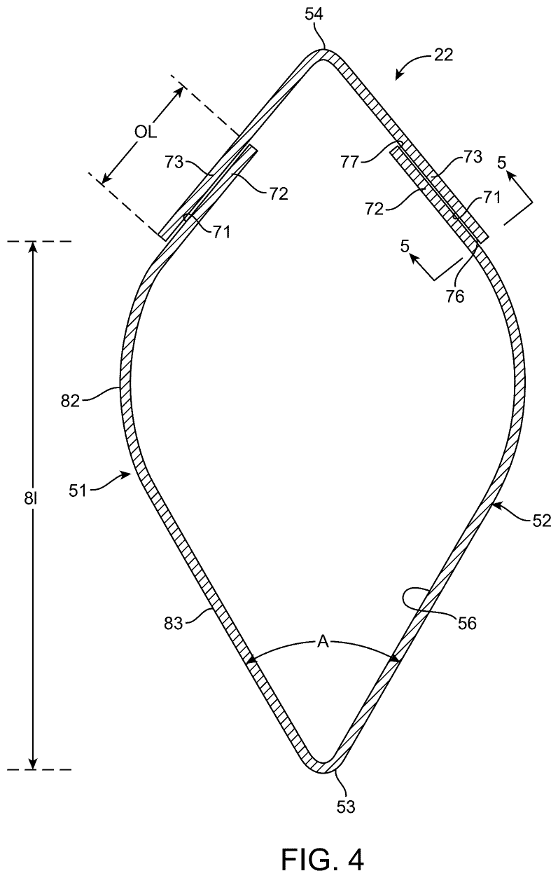

Each plenum 22, 23 of the device 21 can optionally have a length extending between its ends 26, 27 that approximates the width of the surface 36, for example extends across or substantially across the width of the surface, or the width or any arrangement or configuration of products. Each of the plenums is formed with a first or left side wall 51 and an opposite second or right side wall 52 (see FIG. 4). The side walls join together at their respective one or forward ends to form the forward end or bottom end 53 of the plenum. The side walls additionally join together at their respective other, rear or upper ends to form the rear end or upper end 54 of the plenum. The side walls 51, 52 optionally provide the plenum with a constant or identical shape or configuration along the length of the plenum. The side walls 51, 52 optionally provide the plenum with a tubular configuration and form a passageway 56 in the plenum that extends from the first end 26 to the second end 27 of the plenum. The passageway 56 can optionally be referred to as an air or other fluid delivery chamber.

Blower 28 of device 21 is coupled to the first end 26 of each of the plenums 22, 23 for providing a pressurized fluid, for example pressurized air, to passageway 56 of each of the plenums. The blower is optionally positioned to the side of surface 36 when the plenums of the device 21 are positioned across the surface for operation. The blower 28 can optionally be positioned outside side walls 41, 42 of the conveyor system 37 when the cooling device is positioned for use with the conveyor system. The blower can be similarly situated when used with an arrangement or configuration of products. The blower 28 can include a controller 57 of any suitable type for operating the blower, for example turning the blower ON and OFF and optionally controlling the speed of the blower and thus the pressure of the fluid provided by the blower to the passageway 56 of the plenums 22, 23.

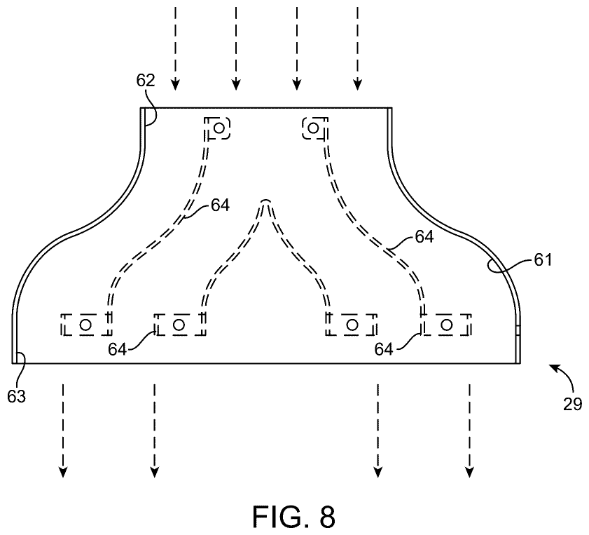

Manifold 29 distributes the pressurized fluid provided by blower 28 to each of the plenums 22, 23. The manifold is optionally configured to provide a uniform flow of the pressurized fluid to each of the plenums of the device 21. The manifold is optionally configured to provide an equal flow of the pressurized fluid to each of the plenums of the device 21. The manifold is optionally configured to provide a uniform air velocity profile to the passageway 56 of each plenum, for example a uniform air velocity profile across the entrance of the passageway. Such uniform air velocity profile optionally does not favor one side, the top or the both of the passageway 56. With respect to the foregoing, the manifold can optionally be provided with an internal chamber 61 having an entrance or inlet 62 coupled to the output of the blower 28 and an exit or outlet 63 coupled to the entrance of the passageway 56 of each plenum of the device 21, for example first plenum 22 and second plenum 23 (see FIGS. 7-8). The manifold can optionally be provided with a plurality of internal vanes or other flower directors 64 for providing the desired flow profile, flow velocity, flow configuration or any combination of the foregoing to the passageway 56 of the one or more plenums of the device 21. Where plenums of the device of the invention are not all of equal size, the manifold of the invention can optionally be configured to distribute the pressurized fluid proportionally to the plenums based on, for example as a function of, the sizes of the plenums.

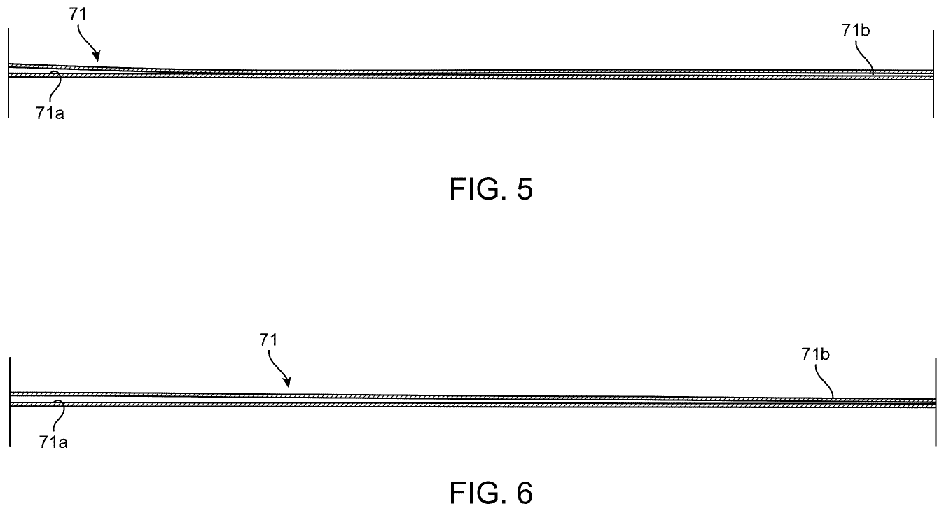

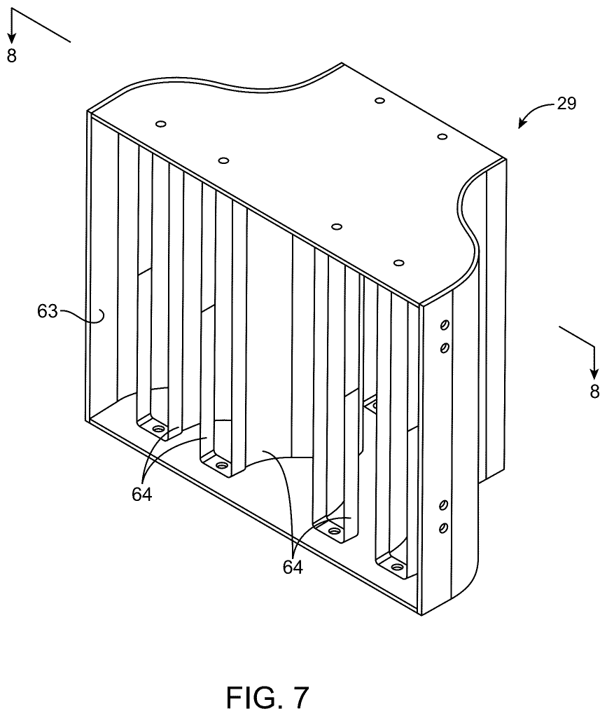

At least one side wall 51, 52 of each plenum 22, 23 of the device 21 is optionally provided with a nozzle, for example a substantially continuous nozzle 71, having a first end 71a and a second end 71b extending along at least a portion of the length of the side wall (see FIGS. 5-6). The first end 71a of the nozzle can be adjacent to the first end 26 of the plenum and the second end 71b of the nozzle can be adjacent to the second end 27 of the plenum. The nozzle 71 optionally points towards the one or more food products. The nozzle 71 optionally directs pressurized fluid from the internal passageway 56 towards the one or more food products. The nozzle 71 serves to direct pressurized fluid from the internal passageway 56 of the plenum for travel over at least a portion of the side wall towards the one or more food products, for example disposed on surface 36. The nozzle can optionally extend along the entire length of the respective side wall 51, 52. The nozzle can optionally extend parallel to the axis 24 of the plenum. The nozzle 71 can optionally be referred to as a linear nozzle. The nozzle can optionally be referred to as a controlled gap in the respective side wall. The nozzle 71 can optionally be continuous or substantially continuous along its length. The nozzle can optionally have a width that reduces or tapers along at least a portion of the length of the plenum, for example reduces along at least a portion of the nozzle from the first end 71a to the second end 71b of the nozzle. Such a narrowing, reduction or tapering of the nozzle along its length can serve to create a pressure drop from the inlet of the passageway 56 of the plenum, adjacent manifold 29, to the opposite closed end of the passageway for facilitating the creation of uniform flow from the nozzle 71 along its length, for example the length of the respective plenum. For example, as shown in FIG. 5, the nozzle 71 can reduce in width along a suitable portion of at its first end 71a and then have a constant width along the remainder of its length to second end 71b of the nozzle. The nozzle 71 can optionally taper or reduce in width for the first ⅙ of its length and then have a constant width for the remaining ⅚ of its length. Alternatively, as shown in FIG. 6, the nozzle 71 can reduce continually or linearly, for example by the same amount, along its entire length from its first end 71a to its second end 71b. A nozzle 71 of any such suitable type can optionally be provided on both the first side wall 51 and the second side wall 52 of one or both of plenums 22, 23, it being appreciated that the number of nozzles and configuration of nozzles can be varied as desired for the cooling operation of device 21.

The construction of a nozzle 71 can be of any suitable type or manner for providing the desired flow of pressurized fluid from the internal passageway 56. A side wall 51, 52 having a nozzle therein can optionally be provided with overlapping wall elements. For example, an underlying wall element 72 extending towards rear end 54 of the plenum 22, 23 and an overlying wall element 73 extending over the underlying element 72 away from rear end 54 and across the entire length of the nozzle 71 can be provided (see FIG. 4). The gap, which can also be referred to as the distance, between the overlying wall element 73 and the underlying wall element 72 can be controlled to determine the width of the respective nozzle 71. The overlapping wall elements end at an external opening or exit 76, formed by the end of the overlying wall element 72, that faces towards forward end 54 and serves as the opening of the nozzle 71. The exposed internal end of the underlying wall element 72 serves as the internal entrance 77 of the nozzle 71. The overlying wall element 73 can extend over the underlying wall element 72, shown as OL in FIG. 4, by any suitable amount. One or both of such overlap and gap can be sized to create sufficient back pressure to promote uniform velocities and to create a fully developed air flow profile that emerges from the nozzle and achieves good air entrainment performance by the plenum. Optional spacers, not shown, can be provided between the overlying wall element 73 and the underlying wall element 72 periodically along the length of the nozzle 71 for maintaining the desired width of the nozzle. Such spacers are optionally sized and spaced so as to not have a noticeable effect on the nozzle performance.

A side wall of the side 51, 52 provided with a nozzle 71, for example the portion of the side wall between the nozzle and the forward end 53 of the plenum 22, 23, can optionally be configured so that the pressurized fluid traveling over the side wall entrains fluid external of the plenum for amplified cooling of products, for example food products on the surface 36 or food products in an arrangement or configuration for processing. Such portion of the side wall can optionally be referred to as an operative wall of the plenum (see FIG. 4).

The portion of the operative wall 81 adjacent to the nozzle 71 and extending toward the forward end 53 can optionally be provided with a Coanda surface 82. A Coanda surface is a known type of surface over which fluid flow exiting an output orifice, such as nozzle 71, close to the surface exhibits the Coanda effect. The fluid tends to flow over the surface closely, almost ‘clinging to’ or ‘hugging’ the surface. The Coanda effect is a well-documented method of entrainment in which a primary air flow is directed over a Coanda surface. A description of the features of a Coanda surface, and the effect of fluid flow over a Coanda surface, can be found in articles such as Reba, Scientific American, Volume 214, June 1966, Pages 84 to 92. Through use of a Coanda surface, an increased amount of air from outside the cooling device 21 is directed by the pressurized fluid emitted from the nozzle 71 of the plenum 22, 23. The Coanda surface 82 can optionally be a curved or arcuate surface, for example a convex surface.

The operative wall 81 can optionally include a diffuser surface 83 between the Coanda surface 82 and the forward end 53 of the plenum 22, 23. The diffuser surface 83 can optionally enhance the amplification properties of the cooling device while minimizing noise and frictional losses over such surface. The opposite diffuser surfaces 83 can optionally taper towards the forward end 53 of the plenum at any suitable angle, for example angle A shown in FIG. 4.

The portion of each side wall 51, 52 between a nozzle 71 of the wall and the rear end 54 of the wall can optionally be referred to as the rear portion 86 of the wall. The rear portion 86, which includes overlying wall element 73, is optionally substantially or entirely linear or straight.

Cooling device 21 and plenums 22, 23 can be desirably sized and shaped to optimize for the specific operation thereof and providing uniform fluid flow from the cooling device during the operation. The air pressure in each of the plenums can optionally be four inch water column or ranging from two inch to eight inch water column. The distance between the forward end 53 and the rear end 54 of a plenum, which can be referred to as the height of the plenum, can optionally be 8.5 inches. The distance or width between the side walls 51, 52 of a plenum at the maximum width of the plenum, which can be referred to as the widest point of the plenum, can optionally range from three inches to nine inches. Such distance can optionally be 4.5 inches. The overlap OL can optionally range from 0.75 inch to 3.00 inch depending on the scale of the plenum or can optionally be 1.4 inch. The dimension of overlap OL, and the other dimensions of the plenum, can optionally scale linearly with the height of the plenum. The plenum ratio, that is the ratio of the plenum volume, for example the volume of the passageway 56, to the flow area of the nozzle to achieve uniform flow velocity from the nozzle, can optionally be a function of the width of the one or more nozzles 71 of the plenum. An optional plenum ratio for use in this calculation is 40 ft³/ft² or more or 12.3 ft³/ft². For example, for a plenum having a constant cross-sectional area, the plenum ratio can optionally be a function of such cross sectional area and the width dimension of the nozzle 71. A plenum with a smaller cross-sectional area can result in a lower plenum ratio. Varying nozzle width, as discussed above, can help mitigate issues with a low plenum ratio. Nozzle spacers, discussed above, can optionally be 0.125 in width. The nozzle spacers can optionally be spaced along the length of the nozzle at intervals ranging from three inches to six inches. The Coanda surface 82 can optionally be a curved surface of any suitable angle, for example having a radius optionally ranging from 1.5 to five inches or optionally 2.6 inches. The nozzle width can optionally be varied to create uniform flow velocities along the length of the nozzle. The radius of the Coanda surface 82 can optionally be scaled linearly with the size of the plenum. The diffuser angle A, that is the angle at the forward end 53 of a plenum between outer diffuser surfaces 83 of side walls 51,52, can optionally range from 15 degrees to 35 degrees or optionally be 30 degrees. The adjoining rear portions 86 of the first side wall 51 and second side wall 52 of a plenum can be joined together at any suitable angle, for example 80 degrees.

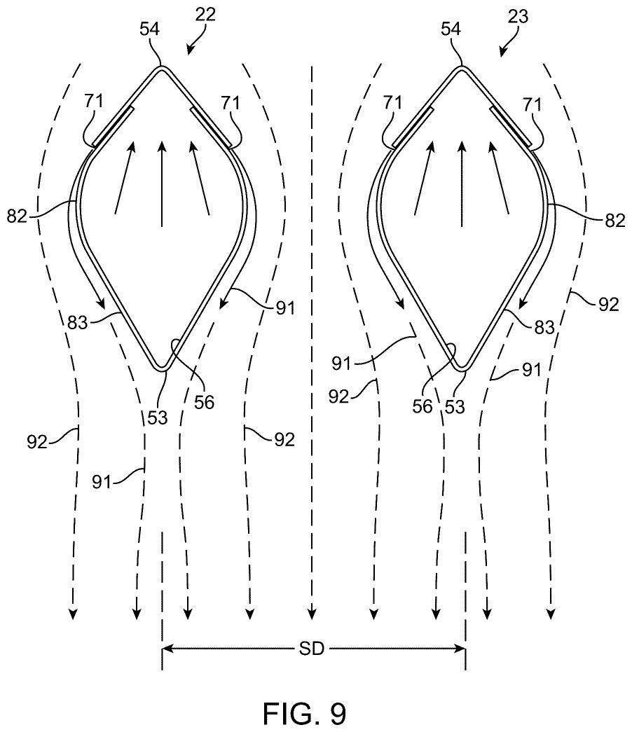

First plenum 22 and second plenum 23 of cooling device can be separated by any suitable center-to-center distance, identified by separation distance SD in FIG. 9, for example eight inches. The separation distance can optionally be a function of the dimensions of the plenums 22, 23 and the pressure of the fluid within the passageway 56 of each plenum. The separation distance can optionally scale with the size of the plenums. A factor in determining the separation distance SD between adjacent plenums of the cooling device 21 can optionally be avoiding dead space between the plenums where minimal air velocity of provided. The forward end 53 of the plenums 22, 23 can be positioned any suitable distance from surface 36, for example 16 inches. Such distance can optionally be a function of providing uniform cooling flow from the cooling device 21 to the surface 36 or to the products in the arrangement or configuration of products being cooled in the processing system.

In operation and use, cooling device 21 can be positioned over a food product zone, for example the zone defined by length L in FIG. 1 and width W in FIG. 2, for cooling food products in the zone, for example carried by a surface 36 in the zone. As discussed herein, the device can optionally be used for cooling the food products in any suitable arrangement or configuration of products being processed. The pressurized fluid from nozzles 71 of the cooling device traveling over the respective side walls 51, 52 of the plenums 22, 23 is amplified by the Coanda surfaces 82 (see FIG. 9). The pressurized fluid flow 91 from the nozzles 71 entrains additional fluid external of the plenum, due to the high velocity of the pressurized fluid flow 91, to provide an entrained fluid flow 92 adjacent to the pressurized fluid flow (see FIG. 9). The combined pressurized fluid flow 91 and the entrained fluid flow 92 provide an aggregate cooling flow from or with respect to the respective side wall 51, 52 of a plenum. The diffuser surfaces function to slow down the mean speed of the fluid. This is achieved by moving the air over an area or through a volume of controlled expansion. The divergent passageway or structure forming the space through which the fluid moves typically allows the expansion or divergence experienced by the fluid to occur gradually. In contrast, a harsh or rapid divergence can cause the air flow to be disrupted, possibly causing vortices to form in the region of expansion. Such vortices can cause the air flow to become separated from the expansion surface and result in the generation of uneven flow. Vortices can lead to an increase in turbulence, and associated noise, in the air flow which can result in nonuniform air flow and decreased cooling efficiency. The amplified fluid flow 91 and the further or entrained fluid flow 92 from the plenums 22, 23 combine to provide an aggregate fluid flow directed by the cooling device towards the food product carried by surface 36. Cooling device 21 can optionally provide for a total volume of cooling air movement onto the food product carried by the surface 36 of five times the volume of air flowing from the discharge of the blower 28, which can optionally be referred to as a magnification ratio of the cooling device 21. It is appreciated that cooling device 21 can be configured and sized to provide any suitable magnification ratio. In this regard, the magnification ratio can optionally range from two to ten.

The separation distance SD between the plenums 22, 23 of the cooling device 21 can optionally be determined so that the combined pressurized fluid flow 91 and entrained fluid flow 92 of the plenums provide a uniform cooling flow across the length L of the surface 36, or arrangement or configuration of products, of which the plenums extend (see FIG. 1).

The cooling device of the invention is advantageous in many respects. The cooling device provides uniform cooling to the food or other products for which it is being used and utilizes minimal electrical energy so as to maximize cooling impact. The cooling device has no moving parts over the food product zone for which it is being used. In this regard, for example, the blower of the cooling device is positioned off to the side of the surface carrying the products being cooled. The cooling device induces more air volume for cooling by using the Coanda effect, which can reduce the size of the fan and the energy and motor required to achieve the cooling process of the device. The cooling device of the invention can optionally provide for a total volume of cooling air movement onto the food product carried by the surface 36 of five times the volume of air flowing from the discharge of the blower, which can optionally be referred to as a magnification ratio of the cooling device. Factors or characteristics of the cooling device that contribute to the uniformity of the cooling produced by it include the entry point of the air delivery chamber passageway of each plenum for fluid from a fan directed by turning vanes, the physical shape of the air delivery chamber or passageway and the adjustment of the gap of each nozzle to create uniformity in flow from the nozzle along the length of the nozzle. The angled rear portions 86 of the side walls 51, 52 of the plenums 22, 23 provide minimal horizontal surfaces to the plenums that can collect debris, for example above the product being cooled.

We claim:

1. A cooling device for food products disposed in an arrangement having a transverse dimension, comprising an elongate plenum having a first end and an opposite second end and a length extending between the first end and the second end approximating the transverse dimension, a structure coupled to the elongate plenum adapted for positioning the elongate plenum across the arrangement, the elongate plenum being provided with a passageway extending from the first end to the second end and having a side wall, a blower coupled to the first end of the elongate plenum for providing a pressurized fluid to the passageway, the elongate plenum having a substantially continuous nozzle extending along its length for directing pressurized fluid from the passageway for travel over the side wall towards the arrangement, the side wall having a configuration so that the pressurized fluid traveling over the side wall entrains fluid external of the elongate plenum for amplified cooling of food products in the arrangement.

2. The cooling device of claim 1, wherein the side wall includes a Coanda surface extending the length of the elongate plenum adjacent the nozzle.

3. The cooling device of claim 2, wherein the side wall includes a diffuser surface extending the length of the elongate plenum adjacent the Coanda surface towards a front of the elongate plenum.

4. The cooling device of claim 3, wherein the diffuser surface tapers to the front of the elongate plenum.

5. The cooling device of claim 1, wherein the blower is positioned to the side of the arrangement when the elongate plenum is positioned across the arrangement for operation.

6. The cooling device of claim 1, wherein the second end of the elongate plenum is closed.

7. The cooling device of claim 1, wherein the elongate plenum has an additional side wall opposite the first-named side wall and an additional substantially continuous nozzle extending along its length for directing pressurized fluid from the passageway for travel over the additional side wall towards the arrangement.

8. The cooling device of claim 1, wherein the nozzle has a width that reduces along at least a portion of the length of the elongate plenum from the first end to the second end.

9. The cooling device of claim 8, wherein the width of the nozzle reduces linearly along the entire length of the elongate plenum from the first end to the second end.

10. The cooling device of claim 1, further comprising an additional elongate plenum having a first end and an opposite second end and a length extending between the first end and the second end approximating the transverse dimension, the structure coupled to the additional elongate plenum adapted for positioning the additional elongate plenum across the arrangement adjacent and parallel to the first-named elongate plenum, the additional elongate plenum being provided with a passageway extending from the first end to the second end and having a side wall facing the side wall of the first-named elongate plenum, the blower coupled to the first end of the additional elongate plenum for providing a pressurized fluid to the passageway of the additional elongate plenum, the additional elongate plenum having a substantially continuous nozzle extending along its length for directing pressurized fluid from the passageway for travel over the side wall towards the arrangement, the side wall of the additional elongate plenum having a configuration so that the pressurized fluid traveling over the side wall entrains fluid between the elongate plenum and the additional elongate plenum for amplified cooling of food products in the arrangement.

11. The cooling device of claim 1 for food products disposed on a surface having a transverse dimension, wherein the structure coupled to the elongate plenum is adapted for positioning the elongate plenum across the surface and the elongate plenum has a substantially continuous nozzle extending along its length for directing pressurized fluid from the passageway for travel over the side wall towards the surface, the side wall having a configuration so that the pressurized fluid traveling over the side wall entrains fluid external of the elongate plenum for amplified cooling of food products on the surface.

12. A cooling device for food products disposed on a surface having a transverse dimension, comprising first and second elongate plenums each having a first end and an opposite second end and a length extending between the first end and the second end approximating the transverse dimension, a structure coupled to the first and second elongate plenums adapted for positioning the first and second elongate plenums spaced apart and in parallel across the surface, each of the first and second elongate plenums being provided with a passageway extending from its first end to its second end and having opposite first and second side walls, a blower coupled to the first end of each of the first and second elongate plenums for providing a pressurized fluid to the respective passageway, a substantially continuous nozzle being provided in each of the opposite first and second side walls of each of the first and second plenums and extending the length of the respective plenum for directing pressurized fluid from the respective passageway for travel over the respective side wall towards the surface, each of the side walls having a configuration so that the pressurized fluid traveling over the side wall entrains adjacent fluid, the first and second elongate plenums providing amplified cooling of food products on an area of the surface.

13. The cooling device of claim 12, wherein each of the side walls of each of the first and second elongate plenums includes a Coanda surface extending the length of the respective elongate plenum adjacent the respective nozzle.

14. The cooling device of claim 13, wherein each of the side walls of each of the first and second elongate plenums includes a diffuser surface extending the length of the respective elongate plenum adjacent the respective Coanda surface towards a front of the respective elongate plenum.

15. The cooling device of claim 14, wherein the diffuser surface tapers to the front of the respective elongate plenum that faces the surface when the elongate plenum is positioned across the surface for operation.

16. The cooling device of claim 12, wherein the nozzle of each of the side walls of each of the first and second elongate plenums has a width that reduces along at least a portion of the length of the respective elongate plenum from the first end to the second end of the respective elongate plenum.

17. A cooling device for use with food products, comprising an elongate plenum having a first end and an opposite second end and a length extending between the first end and the second end, the elongate plenum being provided with a passageway extending from the first end to the second end and having a side wall, a blower coupled to the first end of the elongate plenum for providing a pressurized fluid to the passageway, the elongate plenum having a substantially continuous nozzle extending along its length for directing pressurized fluid from the passageway for travel over the side wall, the nozzle having a width that reduces along at least a portion of the length of the elongate plenum from the first end to the second end, the side wall having a configuration so that the pressurized fluid traveling over the side wall entrains adjacent fluid for providing amplified cooling of the food products.

18. The cooling device of claim 17, wherein the width of the nozzle reduces linearly along the entire length of the elongate plenum from the first end to the second end.

19. The cooling device of claim 17, wherein the width of the nozzle reduces in a first portion of the nozzle adjacent the first end and is constant in a second portion of the nozzle adjacent the second end.

20. The cooling device of claim 17, wherein the side wall includes a Coanda surface extending the length of the elongate plenum adjacent the nozzle.

21. The cooling device of claim 20, wherein the side wall includes a diffuser surface extending the length of the elongate plenum adjacent the Coanda surface towards a front of the elongate plenum.

22. The cooling device of claim 21, wherein the diffuser surface tapers to the front of the elongate plenum.
